(19) United States
(12) Patent Application Publication
(10) Pub. No.: US 2025/0148798 A1
(43) Pub. Date: May 8, 2025

(54) METHOD OF PROVIDING IMAGE OF EVENT OCCURING TO VEHICLE AND SYSTEM IMPLEMENTING THE SAME

(71) Applicants: Hyundai Motor Company, Seoul (KR); Kia Corporation, Seoul (KR)

(72) Inventor: Sung Hwan Jun, Hwaseong-si (KR)

(21) Appl. No.: 18/918,556

(22) Filed: Oct. 17, 2024

(30) Foreign Application Priority Data
Nov. 7, 2023 (KR) 10-2023-0152849

(51) Int. Cl. G06V 20/56; G06V 20/40; G06V 20/59

(52) U.S. Cl. CPC G06V 20/56; G06V 20/44; G06V 20/597

(57) ABSTRACT

A method of providing an event site image to a related person in an emergency and an image transmission system includes: determining whether an event has occurred; determining whether it is an emergency by detecting a biosignal of an occupant; and in response to a determination that it is an emergency, transmitting recorded indoor/outdoor images of a vehicle at a time of the event to a management server, which may, in a dangerous situation where a driver of the vehicle loses consciousness or a secondary accident is likely to occur when the vehicle is stopped after the accident, provide recorded images and indoor/outdoor situations of the vehicle at a time of the accident to a person involved with the driver or to an emergency vehicle/tow truck/police car, or the like is dispatched to handle the accident, through real-time streaming, and may respond to the accident more efficiently and rapidly.

### CROSS-REFERENCE TO RELATED APPLICATIONS

This application claims the benefit of Korean Patent Application No. 10-2023-0152849, filed on Nov. 7, 2023, which is hereby incorporated by reference as if fully set forth herein.

### TECHNICAL FIELD

The present disclosure relates to a method of providing an event site video to a related person in an emergency and an image transmission system therefor.

### BACKGROUND

A black box, which is a device generally used in airplanes, may record the altitude and speed of an airplane, an operating state of the airplane, voice information from a cockpit, and communication with a flight control tower to provide information about a situation at the time of an airplane crash or accident, and may use the recordings to determine a cause of the crash or accident.

In recent years, such a technology has been applied to vehicles as a vehicle black box or dash camera to record situations inside and outside a vehicle and identify an accident or theft of the vehicle while the vehicle is traveling or parked.

A typical vehicle black box or dash camera is equipped with a removable memory (e.g., a flash memory, etc.) to store therein captured images and recorded voice. To acquire information from a black box or dash camera installed in a vehicle nearby in the event of an accident or crime, it is required to separate a memory from the black box and mount the memory in a separate reading device (e.g., a personal computer (PC), a smartphone, a card reader, etc.). There is also a black box or dash camera equipped with a display device available on the market, and in this case, a screen may be played directly from the black box.

However, because video and audio from such a black box or dash camera are mainly used to play previous recordings, it may be impossible to identify a situation occurring inside a vehicle in real time.

Therefore, there is a need to develop a device that may transmit in real time a situation inside and outside a vehicle in the event of an emergency occurring to a driver or passengers inside the vehicle and requiring outside help.

### SUMMARY

Embodiments of the present disclosure can solve issues described above.

An embodiment of the present disclosure can provide a method of providing an event site video (also image herein) to a related person in an emergency and an image transmission system therefor, which, in a dangerous situation where a driver of a vehicle loses consciousness due to a major accident or a secondary accident is likely to occur when the vehicle is stopped after the accident, may provide recorded images and indoor/outdoor situations of the vehicle at the time of the accident to a person involved with the driver or to an emergency vehicle/tow truck/police car, or the like, that is dispatched to handle the accident, through real-time streaming, and may thereby respond to a site of the accident more efficiently and rapidly.

To solve the preceding technical problems, an embodiment of the present disclosure can provide a method of providing an image of an event which occurs to a vehicle, the method can include determining whether an event has occurred to the vehicle; determining whether the event is related to an emergency situation by detecting a biosignal of an occupant in the vehicle by a sensor; and in response to a determination that the event is related to an emergency situation, transmitting recorded images of the vehicle related to the event to a management server.

According to an embodiment of the present disclosure, the transmitting of recorded images can include transmitting the recorded images along with a rescue request signal to the management server.

According to an embodiment of the present disclosure, a method may further include acquiring indoor or outdoor images of the vehicle and continuously transmitting the indoor or outdoor images to the management server.

According to an embodiment of the present disclosure, a method may further include authenticating, by the management server, a driver of the vehicle and transmitting the recorded images to at least one preset terminal based on the authenticating.

According to an embodiment of the present disclosure, a method may further include in response to a request from the at least one preset terminal, providing, by the management server, indoor or outdoor images of the vehicle to the at least one preset terminal.

According to an embodiment of the present disclosure, the authenticating can include determining whether the driver is a registered owner, and the at least one preset terminal can include a terminal of a person preset by the registered owner.

According to an embodiment of the present disclosure, the authenticating can include determining whether the driver is a registered owner, and the at least one preset terminal can include a terminal of the registered owner and a terminal of a person preset by the registered owner.

According to an embodiment of the present disclosure, the method may further include selecting, by the management server, a supporter based on a location of the event, and transmitting the recorded images to a terminal of the selected supporter.

According to an embodiment of the present disclosure, the method may further include transmitting, by the management server, indoor or outdoor images of the vehicle to the terminal of the selected supporter through streaming.

According to an embodiment of the present disclosure, the method may further include determining, by the vehicle, whether a request signal of an emergency rescue or an emergency call has been generated, and when it is determined that the request signal has been generated, transmitting, by the vehicle, the request signal along with the recorded images to the management server.

According to an embodiment of the present disclosure, a system can provide an image of an event that occurs to a vehicle, the system can include: at least one camera configured to acquire an image of a situation outside or inside the vehicle; an image processing module configured to process the image acquired by the at least one camera; an event detection module configured to detect whether a collision event has occurred; an image storage module configured to, when the collision event is detected by the event detection module, receive images acquired by the at least one camera related to the event through the image processing module, and store the received images; a data communication module configured to transmit data to an management server; an occupant state detection module configured to detect a state of an occupant of the vehicle; and a control module configured to, when the collision event is detected by the event detection module and it is determined that it is an emergency situation based on the state of the occupant, transmit recorded images stored in the image storage module to the management server through the data communication module.

According to an embodiment of the present disclosure, the control module may be configured to transmit a rescue request signal to the management server through the data communication module.

According to an embodiment of the present disclosure, the control module may be configured to, after transmitting the recorded images, transmit real-time images acquired through the at least one camera to the data communication module through the image processing module.

According to an embodiment of the present disclosure, the occupant state detection module may be configured to detect the state of the occupant by a change in pressure of an airbag after being deployed, a change in tension of a seatbelt, or a movement of the occupant inside the vehicle.

According to an embodiment of the present disclosure, the system may further include an emergency/urgency request module configured to, when it is determined that it is an emergency based on the state of the occupant after the collision event, generate a request signal of an emergency rescue or an emergency call.

According to an embodiment of the present disclosure, the control module may be configured to transmit the request signal of the emergency rescue or the emergency call to the management server through the data communication module, and transmit the recorded images stored in the image storage module to the management server through the data communication module.

According to an embodiment of the present disclosure, the control module may be configured to, after transmitting the recorded images, transmit real-time images acquired through the at least one camera to the data communication module through the image processing module.

According to embodiments of the present disclosure described herein, the method of providing an event site image to a related person in an emergency and the image transmission system therefor may, in a dangerous situation where a driver of a vehicle loses consciousness due to a major accident or a secondary accident is likely to occur when the vehicle is stopped after the accident, provide recorded images and indoor/outdoor situations of the vehicle at the time of the accident to a person involved with the driver or to an emergency vehicle/tow truck/police car, or the like, that is dispatched to handle the accident, through real-time streaming, and may thereby respond to the accident more efficiently and rapidly.

### BRIEF DESCRIPTION OF THE DRAWINGS

FIG. 1 is a block diagram illustrating an example configuration of an automatic image transmission system for automatically transmitting images in an emergency according to an embodiment of the present disclosure.

FIG. 2 is a flowchart illustrating an example method of providing an event site video (also image herein) to a related person in an emergency according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings. Embodiments are not necessarily limited to the example embodiments of the present disclosure and can be understood to include all changes, equivalents, and replacements within the ideas and the technical scopes of the present disclosure.

The terms “module,” “unit,” and/or “-er/or” for referring to elements can be assigned and used interchangeably in consideration of the convenience of description, and thus such terms per se do not necessarily have different meanings or functions. The terms “module,” “unit,” and/or “-er/or” do not necessarily require physical separation.

Although terms including ordinal numbers, such as “first,” “second,” and the like, may be used herein to describe various elements, the elements are not necessarily limited by these terms. These terms can be merely used to distinguish one element from another.

The term “and/or” can be used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it can be understood that another element may be present therebetween. In contrast, when an element is described as “directly coupled” or “directly connected” to another element, it can be understood that there are no other elements therebetween.

The singular forms “a,” “an,” and “the” can be intended to also include the plural forms as well, unless the context clearly indicates otherwise. It can be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, terms including technical and scientific terms used herein can have a same meaning as commonly understood by one of ordinary skill in the art to which the present disclosure pertains. Terms, such as those defined in commonly used dictionaries, can be interpreted as having a meaning that is consistent with their meaning in the context of the relevant art and the present disclosure.

In addition, the term “unit” or “control unit” can be merely a widely used term for naming a controller that controls a specific vehicle function, and does not necessarily a generic functional unit. For example, each controller may include a communication device that communicates with another controller or a sensor to control a function assigned thereto, a memory that stores an operating system (OS), a logic command, input/output information, and the like, and one or more processors that perform determination, calculation, decision, and the like, any combination of or all of which may be in plural or may include plural components thereof, for controlling a function assigned thereto.

A processor may include a semiconductor integrated circuit and/or electronic devices that perform at least one or more of comparison, determination, computation, operations, and decision to achieve programmed functions. The processor may be, for example, any one or a combination of a computer, a microprocessor, a central processing unit (CPU), an application-specific integrated circuit (ASIC), and an electronic circuit (e.g., circuitry and logic circuits).

In addition, computer-readable recording media (or simply memory) can include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, a method of providing an event site video (also “image” herein) to a related person in an emergency and an image transmission system therefor, according to embodiments of the present disclosure, will be described in detail with reference to the accompanying drawings.

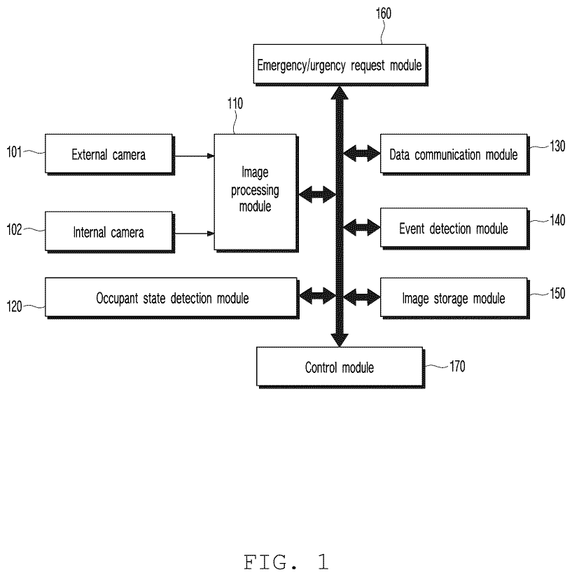

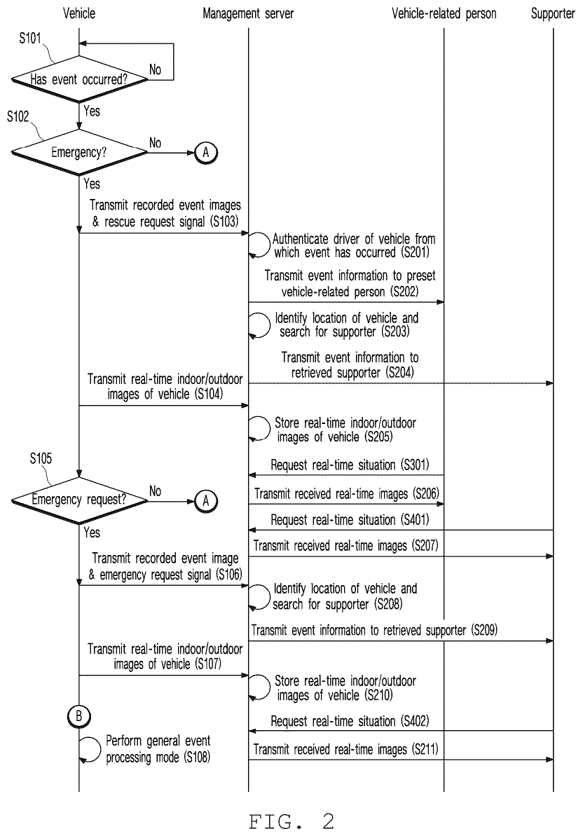

FIG. 1 is a block diagram illustrating an example configuration of an automatic image transmission system for automatically transmitting images in an emergency according to an embodiment of the present disclosure. FIG. 2 is a flowchart illustrating an example method of providing an event site image to a related person in an emergency according to an embodiment of the present disclosure.

As shown in FIG. 1, an image transmission system for transmitting images in an emergency may include: an external camera 101 configured to acquire an image of a situation outside a vehicle; an internal camera 102 configured to acquire an image of a situation inside the vehicle; an image processing module 110 configured to temporarily store and process the images acquired by the external camera 101 and the internal camera 102; an occupant state detection module 120 configured to detect a state of an occupant in the vehicle by detecting a biosignal of the occupant through a biosignal sensor (e.g. a heart rate (HR) sensor) or detecting a change in pressure of an airbag after being deployed, a change in tension of a seatbelt, a movement of the occupant inside the vehicle, or any combination thereof; an event detection module 140 configured to detect whether a collision event has occurred; an image storage module 150 configured to, when the event is detected by the event detection module 140, receive images acquired by the cameras 101 and 102 before and after a time of the event through the image processing module 110, and record and store the received images; a data communication module 130 configured to transmit data input according to a control signal to an external management server; and a control module 170 configured to, when the collision event is detected by the event detection module 140 and it is determined that it is an emergency where the occupant (including a driver) is unconscious by the occupant biosignal detection module 120, transmit recorded event images stored in the image storage module 150 and/or a preset rescue request signal to the management server through the data communication module 130 and then transmit images acquired through the cameras 101 and 102 to the data communication module 130 through the image processing module 110.

The image transmission system may also include an emergency/urgency request module 160 configured to, when the occupant is conscious and it is determined that it is an emergency/urgency situation by the occupant, generate an emergency rescue (or SOS) request signal or an emergency call request signal to seek outside help.

When a signal is generated by the emergency/urgency request module 160, the control module 170 may transmit the SOS request signal or the emergency call request signal to the management server through the data communication module 130 and transmit the recorded event images stored in the image storage module 150 to the management server through the data communication module 130, and may then transmit the images acquired through the cameras 101 and 102 to the data communication module 130 through the image processing module 110.

Each of the modules described above may be implemented by a memory in which a program for performing a corresponding function is stored and a processor configured to execute the program, and the respective memories of the modules may be integrated into one or more memories and the respective processors of the modules may be integrated into one or more processors.

Hereinafter, a process in which signals flow between the automatic image transmission system for automatically transmitting recorded images in an emergency, which can be configured as described above, and an external management server will be described according to an embodiment of the present disclosure with reference to FIG. 2.

In operation S101, the system (or a vehicle) may determine whether an event has occurred, and when it is determined that an event has occurred, proceed to operation S102 to determine whether it is an emergency where an occupant of the vehicle has lost consciousness.

When it is determined that it is an emergency in operation S102, the system may proceed to operation S103 to transmit, to the management server, recorded images in response to the occurrence of the event and a preset rescue request signal.

When the management server receives the recorded images and the preset rescue request signal transmitted in operation S103, the management server may proceed to operation S201 to authenticate a driver of the vehicle from which the event has occurred. The authentication may be performed to determine whether the driver is an owner of the vehicle, or a driver registered by the owner or an unregistered driver based on a vehicle start key such as a smart key or digital key.

After authenticating the driver in operation S201 as described above, the management server may transmit information (or the recorded event images) related to the occurrence of the event to a terminal device (e.g., a smartphone) of a related person (e.g., a vehicle-related person) registered based on the authentication in operation S202.

The vehicle-related person may be, for example, a family member of the owner, when the driver is the owner of the vehicle, and may be, for example, the owner, when the driver is not the owner.

Further, in operation S203, the management server may recognize an event occurrence location at which the event has occurred, and search for an event supporter (e.g., a fire station, a hospital, a driver of an accident support vehicle, etc.) present at a location near the event occurrence location.

Subsequently, in operation S204, the management server may transmit the information (e.g., recorded event images) related to the occurrence of the event to a terminal device (e.g., a personal computer (PC), a smartphone, etc.) of the event supporter retrieved in operation S203.

During operations S201 to S204 described above performed by the management server, when the recorded images are all transmitted in operation S103, the system, or the vehicle from which the event has occurred, may proceed to operation S104 to acquire indoor/outdoor images of the vehicle and continuously transmit them to the management server through streaming.

In operation S205, the management server may store image data transmitted in operation S104. In operation S206 or S207, in response to a real-time event situation request generated by the vehicle-related person or the event supporter in operation S301 or S401, the management server may transmit the images that are being stored in operation S205 to the vehicle-related person and/or the event supporter through streaming.

Even when there is no request from the vehicle-related person or the event supporter in operation S301 or S401, the management server may transmit the images that are being stored in operation S205 to the vehicle-related person and/or the event supporter through streaming, as needed or as programmed.

Thus, the event supporter may be able to accurately recognize a current situation at a site of the event and may thus respond to the accident more efficiently and rapidly.

When it is determined that it is not an emergency in operation S102, the system may proceed to operation S105 to determine whether there is an SOS request signal or an emergency call request signal from the occupant.

When it is determined that there is an SOS request signal or an emergency call request signal from the occupant, the system may proceed to operation S106 to transmit recorded images according to an occurrence of an event and/or the SOS request signal or the emergency call request signal (hereinafter, collectively referred to as an “emergency request signal”) to the management server.

In response to receiving the recorded images and/or the emergency request signal transmitted in operation S106, the management server may proceed to operation S208 to recognize an event occurrence location at which the event has occurred, and search for an event supporter (e.g., a fire station, a hospital, a driver of an accident support vehicle, etc.) present at a location near the event occurrence location.

Subsequently, in operation S209, the management server may transmit information (e.g., recorded event images) related to the occurrence of the event to a terminal device (e.g., a PC, a smartphone, etc.) of the event supporter retrieved in operation S208.

During operations S208 and S209 described above performed by the management server, when the recorded images are all transmitted in operation S106, the system, or the vehicle from which the event has occurred, may proceed to operation S107 to acquire indoor/outdoor images of the vehicle and continuously transmit them to the management server through streaming.

In operation S210, the management server may store image data transmitted in operation S107. In operation S211, in response to a real-time event situation request generated from the event supporter in operation S402, the management server may transmit images that are being stored in operation S210 to the vehicle-related person and/or the event supporter through streaming.

In contrast, when it is determined that no emergency request signal is generated by the occupant in operation S105, the system may proceed to operation S108 to perform a general event processing mode.

While example embodiments of the present disclosure have been shown and described above, it will be apparent to one of ordinary skill in the art that various modifications or changes in form and details may be made in these embodiments without departing from the spirit and scopes of the claims and their equivalents.

What is claimed is:

1. A method of providing an image of an event related to a vehicle, the method comprising:
determining that the event has occurred;
determining that the event is related to an emergency situation by detecting a biosignal of an occupant in the vehicle by a sensor; and
in response to determining that the event is related to the emergency situation, transmitting recorded images related to the event to a management server.

2. The method of claim 1, wherein the transmitting of the recorded images comprises
transmitting the recorded images along with a rescue request signal to the management server.

3. The method of claim 1, further comprising:
acquiring indoor or outdoor images of the vehicle; and
continuously transmitting the indoor or outdoor images to the management server.

4. The method of claim 1, further comprising:
authenticating a driver of the vehicle; and
transmitting the recorded images to at least one terminal based on the authenticating.

5. The method of claim 4, further comprising in response to a request from the at least one terminal, providing indoor or outdoor images from the vehicle to the at least one terminal.

6. The method of claim 4, wherein the authenticating comprises determining whether the driver is a registered owner, and the at least one terminal includes an authorized terminal of a person selected by the registered owner.

7. The method of claim 4, wherein the authenticating comprises determining whether the driver is a registered owner, and the at least one terminal includes an account terminal of the registered owner and an authorized terminal of a person selected by the registered owner.

8. The method of claim 1, further comprising:
selecting a supporter based on a location of the event; and
transmitting the recorded images to a support terminal of the selected supporter.

9. The method of claim 8, further comprising transmitting indoor or outdoor images from the vehicle to the support terminal of the selected supporter through streaming.

10. The method of claim 1, further comprising:
determining whether a request signal of an emergency rescue or an emergency call has been generated; and
in response to it being determined that the request signal has been generated, transmitting the request signal along with the recorded images.

11. A system for providing an image of an event related to a vehicle, the system comprising:
a camera configured to acquire an image of a situation outside or inside the vehicle;
an image processing module configured to process the image acquired by the at least one camera;
an event detection module configured to detect whether a collision event has occurred;
an image storage module configured to, in response to the collision event being detected by the event detection module, receive images acquired by the at least one camera related to the event through the image processing module, and store the received images;
a data communication module configured to transmit data;
an occupant state detection module configured to detect a state of an occupant of the vehicle; and
a control module configured to, in response to the collision event being detected by the event detection module and it being determined that it is an emergency situation based on the state of the occupant, transmit recorded images stored in the image storage module through the data communication module.

12. The system of claim 11, wherein the control module is further configured to transmit a rescue request signal to t through the data communication module.

13. The system of claim 11, wherein the control module is further configured to, after transmitting the recorded images, transmit real-time images acquired through the at least one camera to the data communication module via the image processing module.

14. The system of claim 11, wherein the occupant state detection module is configured to
detect the state of the occupant by one of or any combination of a change in pressure of an airbag after being deployed, a change in tension of a seatbelt, or a movement of the occupant inside the vehicle.

15. The system of claim 11, further comprising an emergency request module configured to, in response to it being determined that it is an emergency based on the state of the occupant after the collision event, generate a request signal of an emergency rescue or an emergency call.

16. The system of claim 15, wherein the control module is further configured to:
transmit the request signal of the emergency rescue or the emergency call through the data communication module; and
transmit the recorded images stored in the image storage module through the data communication module.

17. The system of claim 16, wherein the control module is further configured to, after transmitting the recorded images, transmit real-time images acquired through the at least one camera to the data communication module via the image processing module.

18. A method of providing images of an event related to a vehicle, the method comprising:
capturing a first set of images related to the vehicle;
determining whether the event has occurred;
in response to determining that the event has occurred, storing the first set of images captured before the event;
determining whether the event is related to an emergency situation by detecting a biosignal of an occupant in the vehicle; and
in response to determining that the event is related to the emergency situation, transmitting the first set of images related to the event along with a rescue request signal.

19. The method of claim 18, further comprising:
in response to determining that the event is related to the emergency situation, capturing a second set of images after the event including vehicle interior images of the occupant in the vehicle; and
transmitting the second set of images.

20. The method of claim 18, further comprising:
in response to determining that the event is related to the emergency situation, detecting a state of the occupant by sensing one of or any combination of a change in pressure of an airbag after being deployed, a change in tension of a seatbelt, or a movement of the occupant inside the vehicle; and
transmitting information relating to the state of the occupant.
